(19) United States
(12) Patent Application Publication
(10) Pub. No.: US 2012/0137893 A1
(43) Pub. Date: Jun. 7, 2012

(54) BEVERAGE VENDING MACHINE

(75) Inventor: Sebastian Casado Gomez, Stuttgart (DE)

(73) Assignee: WMF WUERTTEMBERGISCHE METALLWARENFABRIK AG, Geislingen/Steige (DE)

(21) Appl. No.: 13/386,276

(22) PCT Filed: Jul. 23, 2010
(86) PCT No.: PCT/EP2010/060708

§ 371 Date: Feb. 24, 2012

(30) Foreign Application Priority Data
Jul. 23, 2009 (DE) 10 2009 034 322.9

(51) Int. Cl. A47J 31/44; A47J 31/41

(52) U.S. Cl. 99/283; 99/290; 99/280; 99/285

(57) ABSTRACT

The present invention relates to a beverage vending machine, particularly a coffee vending machine. According to the invention, a control device is provided for reducing a power consumption in a standby mode (energy saving mode) by reducing a temperature of a water heater, particularly a boiler temperature, such as that of a pass-through heater or a bare-wire heating system, and the control device is implemented such that it controls or regulates the reduction of the temperature of the water heater, that is, the boiler temperature and/or a waiting period before beginning the reduction, as a function of a beverage dispensing process in a preceding period of time.

### BACKGROUND OF THE INVENTION

1. Field of the Invention

The present invention relates to a beverage vending machine, in particular an automatic coffee maker, according to the preamble of claim 1. The invention also relates to a method for changing a beverage machine to a standby mode (energy-saving mode).

2. Description of the Related Art

Beverage machines and in particular automatic coffee makers are now used not only in the commercial field, but also increasingly in the private sphere, with increasing attention being paid to the subject of energy efficiency in current beverage machines owing to increasing energy costs. Low energy consumption is also increasingly a selling point due to increasing energy costs. It has generally been found that an energy requirement for preparing a beverage is approximately the same in many automatic coffee makers owing to the high energy requirement which arises, but there is a clear difference in standby mode. For this reason, modern automatic coffee makers have what is known as an “ECO mode”, in which the automatic coffee maker automatically switches off, for example after a predefined and preselectable time. It is also known that the automatic coffee maker reduces a kettle temperature to a previously defined value after a few minutes without a beverage being purchased when energy-saving mode (ECO mode) is activated. The time until the reduction is however always the same.

The present invention is concerned with the problem of specifying an improved or at least alternative embodiment for a generic beverage machine, with which energy consumption can be reduced in a standby mode, but which also has a high level of user convenience.

### SUMMARY OF THE INVENTION

The invention is based on the general concept of predefining parameters for an energy-saving mode (standby mode) in a beverage machine, in particular an automatic coffee maker, not in a fixed manner, but variably, so that the energy-saving mode is adaptable. To this end, the beverage machine according to the invention has a control/regulation device, which reduces energy consumption in the standby mode, that is, energy-saving mode, by reducing a kettle temperature, in particular a temperature of a water heater, for example a continuous-flow heater or a bare wire heating system. Of course, this means the standby temperature at which the water heater and the water contained therein is kept, the type or embodiment of the water heater itself being immaterial. It is therefore irrespective of whether the latter is configured as a bare heating wire, continuous-flow heater, unit heater, kettle or boiler. Kettle temperature therefore means the water temperature which prevails in the kettle, continuous-flow heater etc. At the same time, this control/regulation device according to the invention is configured in such a manner that it controls or regulates the reduction of the kettle temperature and/or a waiting time until the start of the reduction depending on a beverage output which has taken place in a previous time period. The time after which the beverage machine according to the invention changes to energy-saving mode is therefore not rigidly predefined but dependent on a withdrawal behaviour which has taken place previously, for example on a number of output beverages which has previously taken place or on a time span between the individual beverage outputs. At the same time, the control/regulation device according to the invention can control or regulate the change of the beverage machine to the standby mode thereof depending on the previously selected beverage types, so for example a change is made to energy-saving mode earlier when a cold beverage is output than when hot beverages such as coffee are repeatedly output. In the latter case the energy-saving mode is activated later, as a result of which the beverage machine is also however ready for use more quickly. In particular, increased user convenience can be provided by the beverage machine according to the invention at use locations with only occasional withdrawals and long pauses in between, as, as long as hot beverages have been withdrawn previously, the beverage machine is changed to energy-saving mode later and thus a waiting time until full readiness for use of the beverage machine is shorter when a hot beverage has previously been output than is the case for example in beverage machines which change to the energy-saving mode after a precisely predefined time span. Furthermore, an energy-saving function can be adapted continuously to a current withdrawal behaviour and thus to the respective operating conditions with the control/regulation device according to the invention. The invention can furthermore be realised by a simple change in the software of an already previously used control/regulation device, so the extra monetary outlay for realising the invention is comparatively small. An adjustment effort for the user which is often perceived to be inconvenient is also reduced by the automatic adaptation of the change to standby mode, as a result of which user convenience can be improved.

In an advantageous development of the solution according to the invention, the beverage machine has an ECO mode and a long-term ready mode, the control/regulation device being active including in the ECO mode. With the differentiation between these two modes, it is left up to the customer or user of the beverage machine whether he prefers long-term readiness of the beverage machine or an energy-saving function of the same.

In a further advantageous embodiment of the solution according to the invention, the control/regulation device is configured in such a manner that it reduces the temperature of the water heater, that is, the kettle temperature, in stages. It is thus conceivable that when the beverage machine changes to its energy-saving mode, the kettle temperature is reduced not suddenly but in stages and thus much more slowly, so that when necessary a desired restart of the beverage machine after a relatively short time is possible more quickly than would be the case if the temperature of the water heater, that is, the kettle temperature, was not reduced in stages.

A grinding, pressing and/or brewing process expediently takes place before a brewing temperature is reached, as a result of which a quicker restart can be achieved. When a beverage request is input into the beverage machine, the heating device is thus activated directly to heat the water necessary for a brewing process, while grinding of the coffee, pressing of the same or prebrewing of the same takes place before the brewing temperature is reached in the kettle of the beverage machine, so the waiting time between input of the beverage request and output of the actual beverage is shortened and therefore the benefit to the customer can be increased.

In a further advantageous embodiment of the solution according to the invention, the beverage machine has a display on which a reduction state of the temperature of the water heater, that is, the kettle temperature, is displayed. This makes it easily possible at any time for a user of the beverage machine to find out the operating or standby mode in which the beverage machine currently is and how long he must wait for a desired beverage. Of course, a display which is usually arranged on the beverage machine can be used for this or else a separate display can be provided, which can for example differ according to the desired equipment line.

With the beverage machine according to the invention, which controls or regulates its energy-saving mode depending on a beverage output, a particularly energy-saving appliance can be offered on the market which is at the same time particularly user-friendly, as it can be adapted to a respective withdrawal behaviour, in particular as the beverage machine adjusts automatically to the withdrawal behaviour which has just taken place. In particular, shorter restart times can also be achieved thereby, which likewise contributes to increased benefit to the customer. Compared to beverage machines which are always in operating mode, a considerable saving on energy can be achieved with the beverage machine according to the invention, which is likewise advantageous with respect to continually rising energy costs.

### BRIEF DESCRIPTION OF THE DRAWING

FIG. 1 is a schematic illustration of a beverage machine in accordance with an embodiment of the invention.

### DETAILED DESCRIPTION OF THE PREFERRED EMBODIMENT

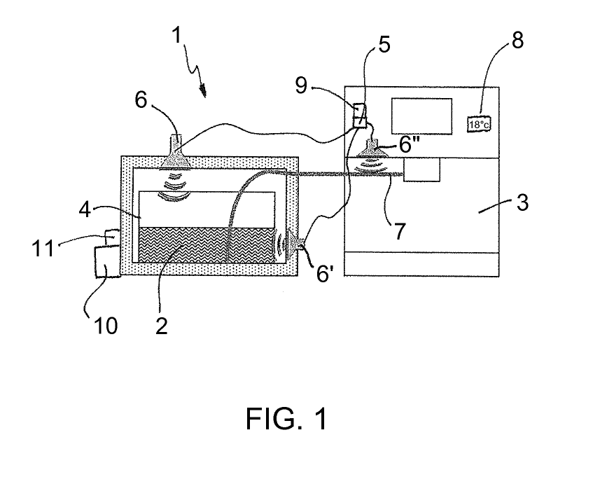

A beverage machine in accordance with the invention is embodied as an automatic coffeemaker and is identified generally by the numeral 10 in FIG. 1. The coffeemaker 10 includes a water kettle 12 with a heater 14 for heating water in the kettle 12. An apparatus 16 optionally is provided for grinding, pressing or prebrewing the coffee. The coffeemaker 10 also includes a display 18 to display the operating conditions of the coffeemaker 10, including temperature of the water in the kettle 12. A user input 20 also is provided for starting or controlling the brewing process. A control unit 22 is connected to the display 18 and to heater 14. The control unit 22 controls the temperature at which the heater 14 will operate. More particularly, the control unit 28 will switch the heater 14 into a standby mode or an energy-saving mode under certain conditions that may be dependent at least in part on the beverage output that has taken place in a previous time period.

1. A beverage machine, comprising:
at least one heater;
a storage for storing information regarding beverage output that has taken place in a previous time period,
a control/regulation that reduces energy consumption in a standby mode by reducing a temperature of the heater,
the control/regulation device being configured to control at least one of the reduction of the temperature of the heater and/or a waiting time until the start of the reduction depending on the beverage output that has taken place in the previous time period.

2. The beverage machine according to claim 1, characterised in that
the control/regulation device is configured in such a manner that it controls/regulates the reduction of the temperature of the heater and/or a waiting time until the start of the reduction depending on the type of beverage output and/or an output cycle.

3. The beverage machine according to claim 1, characterised in that
the beverage machine has an ECO mode and a long-term ready mode, wherein the control/regulation device is only active in ECO mode.

4. The beverage machine according to claim 1, characterised in that
the control/regulation device is configured in such a manner that it reduces the temperature of the water heater, in particular the kettle temperature, in stages.

5. The beverage machine according to claim 1, characterised in that
a grinding, pressing and/or pre-infusion process takes place before a brewing temperature is reached, in order to achieve a quicker restart.

6. The beverage machine according to claim 1, characterised in that
the beverage machine has a display on which a reduction status of the kettle temperature can be displayed.

7. A method for changing a beverage machine, in particular an automatic coffee maker, to a standby comprising
reducing energy consumption the standby mode by reducing a temperature of a water heater, and
regulating at least one of the reduction of the temperature of the water heater, and a waiting time until the start of the reduction depending on a beverage output which has taken place in a previous time period.
